(19) United States
(12) Patent Application Publication
(10) Pub. No.: US 2010/0241503 A1
(43) Pub. Date: Sep. 23, 2010

(54) Digital Signage System And Display Terminal

(75) Inventor: Hisaharau NAKASHIMA, Souraku-gun (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/727,520

(22) Filed: Mar. 19, 2010

(30) Foreign Application Priority Data
Mar. 19, 2009 (JP) 2009-067348

(51) Int. Cl. G06Q 30/00; G06F 15/00; G06K 9/00; G06F 3/041

(52) U.S. Cl. 705/14.19; 358/1.15; 382/118; 705/14.66; 345/173

(57) ABSTRACT

A digital signage system according to the present invention has: a server that distributes content information for an advertisement and the like; and one or more display terminals that are provided with a touch panel and that receive the distributed content information to be displayed on the touch panel. The display terminal displays a questionnaire screen on the touch panel, accepts a response to the questionnaire inputted by an accesser by operating the touch panel, and sends the result of the response to the server. The server receives the result of the response.

### CROSS-REFERENCE TO RELATED APPLICATIONS

This application is based on Japanese Patent Application No. 2009-67348 filed on Mar. 19, 2009, the contents of which are hereby incorporated by reference.

### BACKGROUND OF THE INVENTION

1. Field of the Invention

The present invention relates to a digital signage system for distributing and displaying content information, and to a display terminal.

2. Description of Related Art

The digital signage system has conventionally been used as means for providing information such as an advertisement to the general public (e.g. passers-by). The digital signage system typically includes: a server that distributes content information containing, for example, product advertisements and various information; and a display terminal that displays content information distributed by the server.

The digital signage system can be used for various purposes, and as an example, the digital signage system can be used to advertise a product to expand sales thereof. That is, advertisement content offered by a sponsor is registered in a server and distributed to be displayed on a display terminal placed, for example, on a street corner. The sponsor can thereby present people with product information and the like, which can be expected to help enhance the product image and the brand image.

As described above, a sponsor can present people with product information and the like by using the digital signage system. However, the system does not allow the sponsor to obtain information (trend information) such as trends of needs and preferences people have with respect to products. Such trend information helps expand product sales, and thus is very useful to the sponsor. Thus, the digital signage system should desirably be capable of obtaining trend information (that is, capable of conducting trend research).

It may seem possible to obtain trend information by using the digital signage system if only the display terminal is so built as to allow a person who accesses it (an “accesser”) to input information thereto. However, if a difficult information input method is adopted, or if no benefit (such as a reward for inputting information) is offered to accessers, it cannot be expected that many people will input information, and as a result, it is difficult to obtain highly reliable trend information.

### SUMMARY OF THE INVENTION

According to one aspect of the present invention, a digital signage system includes: a server that distributes content information for an advertisement and the like; and one or more display terminals that are provided with a touch panel and that receive the distributed content information to be displayed on the touch panel. Here, the display terminals display a questionnaire on the touch panel, accept a response to the questionnaire inputted by an accesser by operating the touch panel, and send a result of the response to the server, and the server receives the result of the response. According to another aspect of the present invention, a display terminal includes: a touch panel; and a communication portion that performs communication with a server that distributes content information for an advertisement and the like, the display terminal receiving content information distributed by the server to be displayed on the touch panel. Here, the display terminal displays a questionnaire on the touch panel, accepts a response to the questionnaire inputted by an accesser by operating the touch panel, and sends a result of the response to the server.

### BRIEF DESCRIPTION OF THE DRAWINGS

These and other objects and features of the present invention will be understood more clearly from the following descriptions of preferred embodiments and accompanying drawings that are briefly summarized below.

FIG. 1 is a diagram showing the structure of a digital signage system according to an embodiment of the present invention.

FIG. 2 is a diagram showing the structure of a display terminal according to an embodiment of the present invention.

FIG. 3 is a diagram for illustrating questionnaire information.

FIG. 4 is a diagram for illustrating coupon information.

FIG. 5 is a diagram for illustrating a summary table.

FIG. 6 is a flow chart of processes executed in the digital signage system.

FIG. 7 is a diagram for illustrating a questionnaire screen.

### DETAILED DESCRIPTION OF PREFERRED EMBODIMENTS

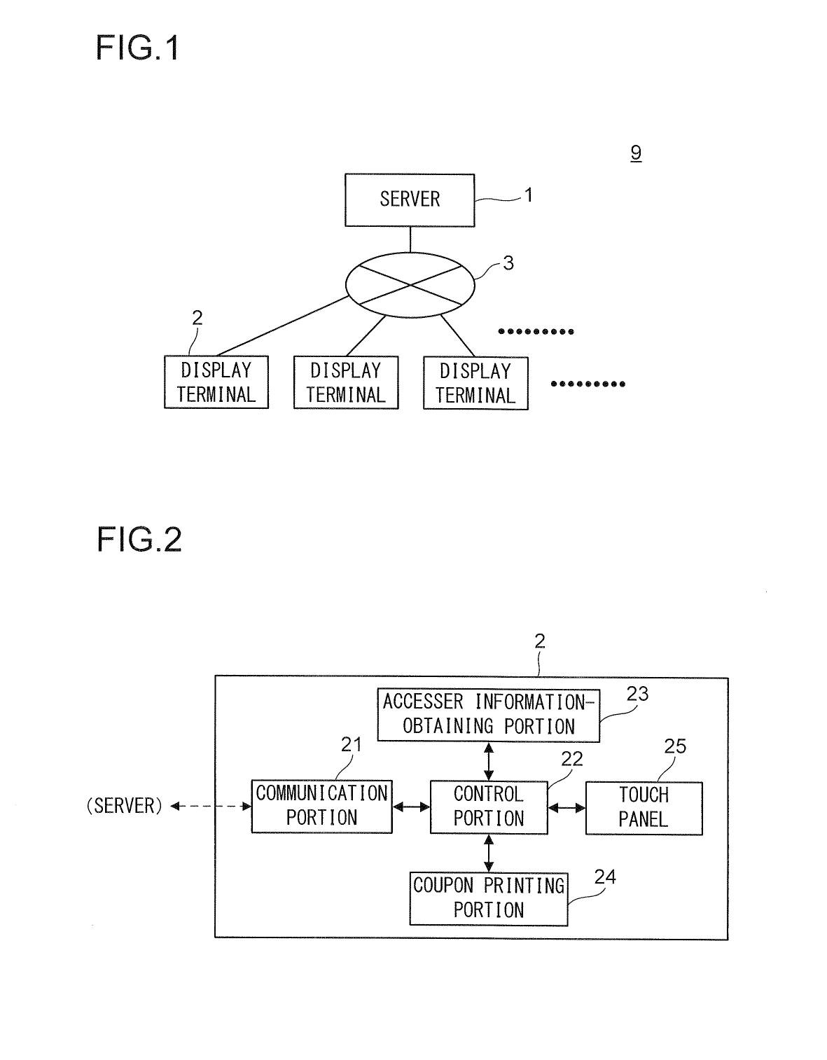

An embodiment of the present invention will be described below with reference to the accompanying drawings. FIG. 1 is a diagram schematically showing the structure of a digital signage system according to this embodiment. As shown in the figure, the digital signage system 9 has a server 1, a display terminal 2, a network 3, and the like.

The server 1 has a memory device that stores various information, a communication device that communicates with the display terminal 2 via the network 3, a calculation/control device that executes calculation and control necessary in the server 1, and the like. The server 1 stores in advance, or as necessary, content information, questionnaire information, coupon information, and the like.

The content information is information offered as necessary by a sponsor and the like, and includes information for a product advertisement (product promotion), information distributed as an information providing service, and the like. This, however, is not meant to limit the specific contents of the content information. A plurality of kinds of pieces of content information are prepared to be sent as necessary to the display terminal 2 to be displayed thereon.

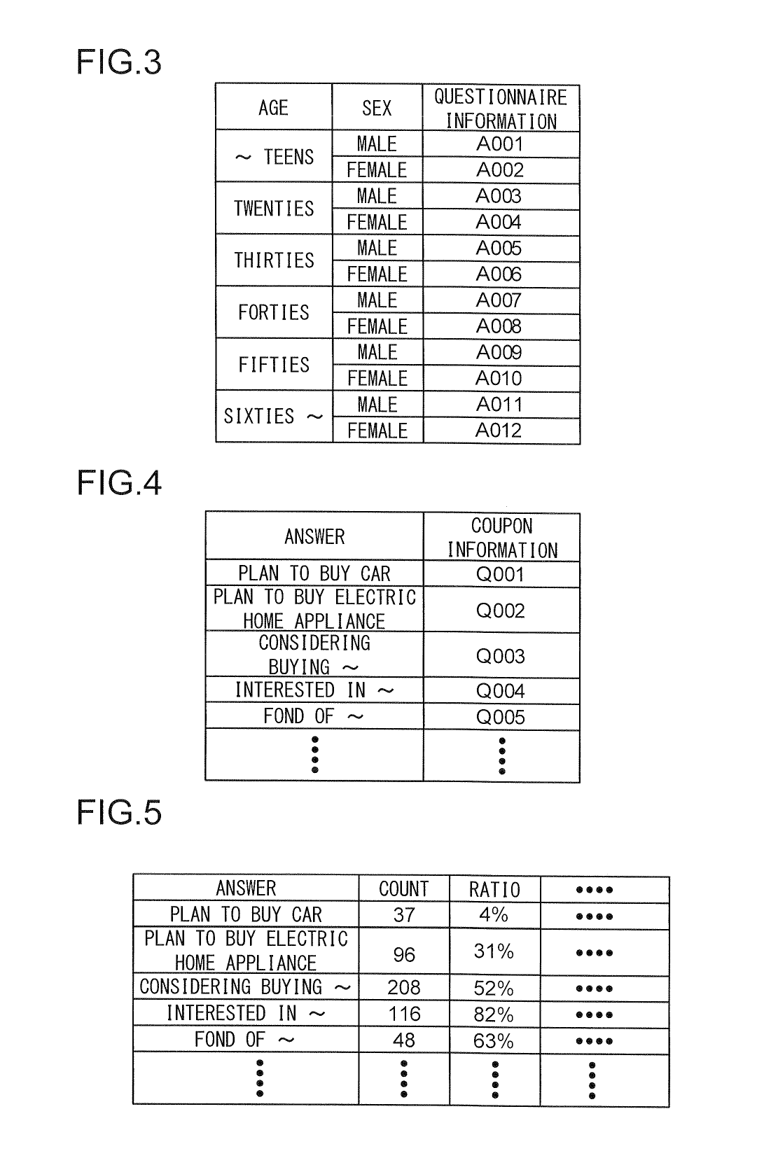

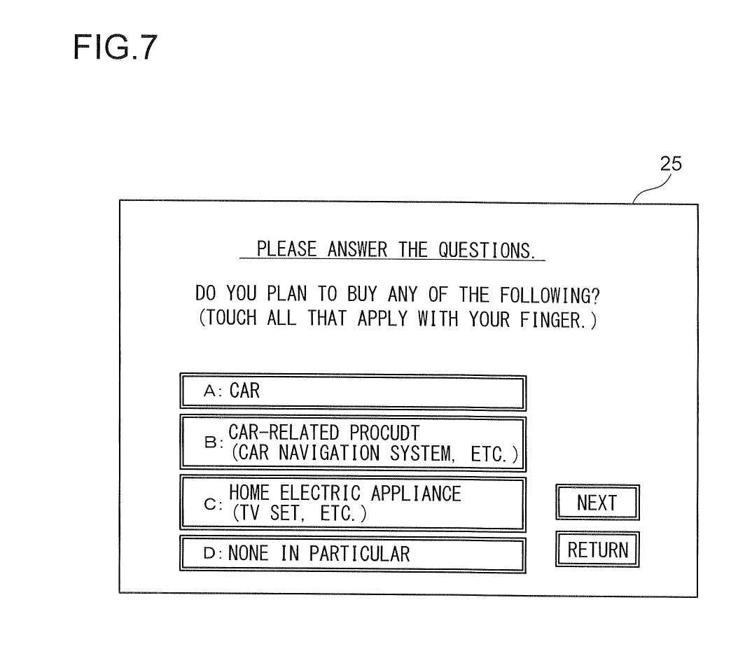

The questionnaire information is information for determining the contents of a questionnaire screen (see FIG. 7) to be displayed on the display terminal 2, and is sent to the display terminal 2 as necessary. As shown in FIG. 3 a plurality of different kinds of pieces of questionnaire information (here, 12 kinds of A001 to A012) are prepared for respondents (accessers) of different age and sex such that a questionnaire appropriate for each respondent (accesser) is presented according to his/her age and sex. For example, the contents of questionnaire information for a woman in her twenties are focused on cosmetics and fashion, while those of questionnaire information for a man in his fifties are focused on golf gears and men's wear.

The coupon information is information for determining the contents of a service coupon to be printed at the display terminal 2, and is sent to the display terminal 2 as necessary. As shown in FIG. 4, a plurality of different kinds of pieces of coupon information are prepared so as to issue a coupon that reflects a result of a response (answer) to a questionnaire inputted by a respondent (accesser) and that meets the needs of the respondent. For example, a “Discount Coupon for Electric Home Appliances” is issued for an accesser who has answered that he/she plans to buy an electric home appliance, and a “Complementary Ticket for Golf Course” is issued for an accesser who answers that he/she is interested in golf.

Furthermore, a summary table for summarizing response results is also stored in the memory device of the server 1. For example, as shown in FIG. 5, separately for each response result (answer), count (accumulated number of times when an answer is received), frequency (ratio of the number of times when an answer is received), and the like are recorded in the summary table.

As the display terminal 2, which displays (reproduces) content information distributed from the server 1 and accepts response to questionnaires from accessers, one or more display terminals are provided at a location or locations (for example, on a wall of a shopping mole) accessible to people such as passers-by. As shown in FIG. 2, the display terminal 2 is provided with a communication portion 21, a control portion 22, an accesser information-obtaining portion 23, a coupon-printing portion 24, a touch panel 25, and the like.

The communication portion 21 is a functional portion that executes communication with the server 1 via the network 3. The control portion 22 is formed with, for example, a CPU, and controls the portions in the display terminal 2 to execute necessary processes. The major processes executed in the display terminal 2 will be described later.

The accesser information-obtaining portion 23 is a functional portion that obtains information (accesser information) regarding age and sex of accessers. More specifically, the accesser information-obtaining portion 23 obtains an image of an accesser's face by using an image sensing device provided for shooting an image of the face of a person existing in front of the display terminal 2 (that is, an accesser). And, the accesser information-obtaining portion 23 obtains accesser information from the thus obtained image (for example, by applying a pattern matching method using face patterns of different ages).

Incidentally, the information regarding the age of an accesser does not necessarily need to indicate the exact age, and it may be information roughly indicating the age of an accesser, such as, which age group an accesser belongs to or whether an accesser is an adult or a child. As for the method of obtaining the accesser information, another method (for example, requesting accessers to input information) may be adopted in place of, or as an auxiliary method of, the above-described method.

The coupon-printing portion 24 is provided with functions of storing predetermined sheets of paper (coupon paper), printing coupon information on the paper, ejecting the paper (service coupon) on which coupon information is printed, and the like. The service coupon is ejected to be available for the accesser. The coupon-printing portion 24 makes it possible for the digital signage system 9 to issue service coupons to accessers. Incidentally, the service coupons are, for example, discount coupons and complementary tickets, and offer some economical benefits to accessers.

The touch panel 25 is formed by covering a display, on which various information is displayed, with a transparent panel that detects a position thereon touched by an accesser. The touch panel 25 functions as means for displaying information and as means through which accessers input information. The touch panel 25 also allows accessers to input various information intuitively therethrough following instructions displayed on the touch panel 25. Thus, accessers can input information more easily than with information input means with operation buttons or the like provided separately from a display.

Furthermore, the network 3 connecting the server 1 and the display terminals 2 to each other is realized, for example, by the Internet and a LAN (local area network). The network 3 may be either wired or wireless or both.

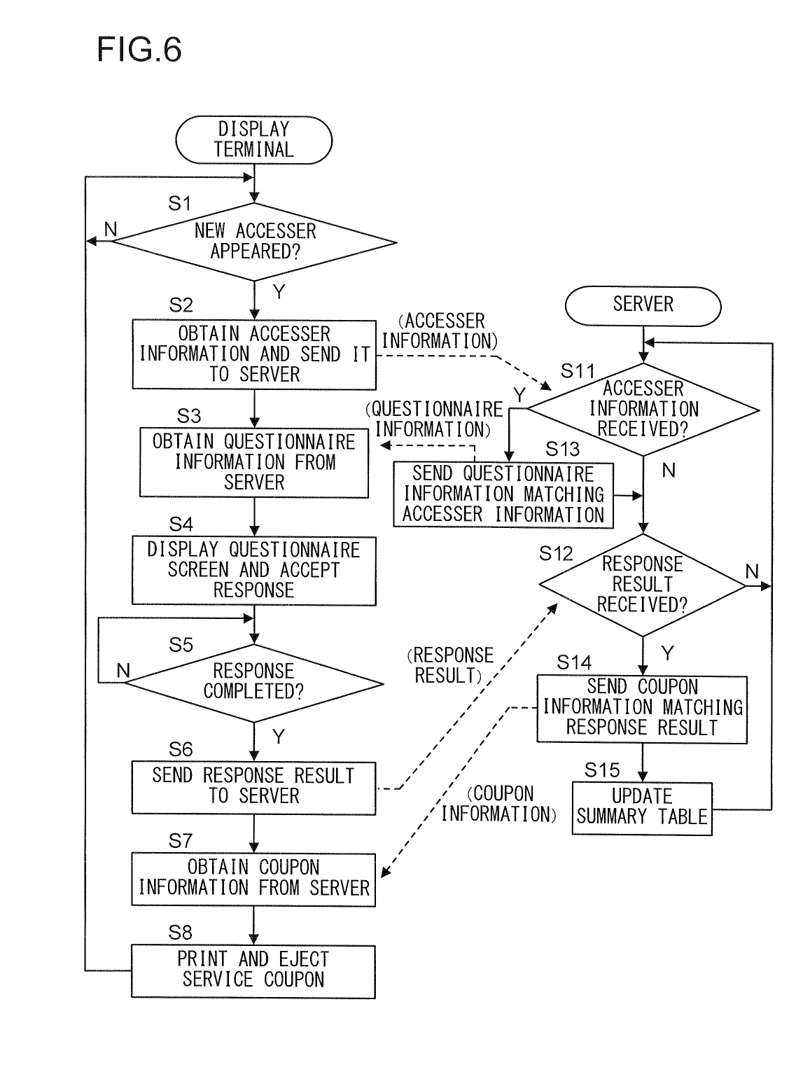

With the structure described above, the digital signage system 9 presents content information to people in the vicinity of the display terminal 2. That is, content information distributed from the server 1 is displayed on the display terminal 2. The digital signage system 9 is further provided with a function of conducting trend research. Now, the process related to the function will be described below with reference to the flow chart illustrated in FIG. 6.

The display terminal 2 continues to observe whether or not someone makes access thereto (that is, whether or not a new accesser appears) during an access-waiting period (during which no access is being made to the display terminal 2) (step S1). Incidentally, the display terminal 2 determines that a new accesser has appeared when a person touches the touch panel 25 (the person who has touched the touch panel 25 is regarded as an accesser), or when a person is detected to have stopped in front of the display terminal 2 (the person who has stopped in front of the display terminal 2 is regarded as an accesser).

If an accesser appears (Y in step S1), the accesser information-obtaining portion 23 obtains the accesser information of the accesser and sends it to the server 1 (step S2). ID (identification data) information of the display terminal 2 in which the accesser information-obtaining portion 23 is provided is also sent to the server 1 along with the accesser information. Thus, even when a plurality of display terminals 2 are provided as the display terminal 2, the server 1 can recognize which of the display terminals 2 has sent the accesser information.

On receiving accesser information, the server 1 sends questionnaire information to the display terminal 2 that has sent the accesser information to the server 1 (step S13, which will be described later). The display terminal 2 receives the questionnaire information (step S3), and then makes the touch panel 25 display a questionnaire screen to accept a response from the accesser (step S4).

An example of contents of the questionnaire screen is shown in FIG. 7. That is, a question for the accesser and a message inviting the accesser to answer the question are displayed in the questionnaire screen. In a case where the question requires the accesser to select one from among some options, the options are also displayed. When a position on the questionnaire screen at which an option is displayed is pressed down by, for example, a finger, the display terminal 2 determines that the option is selected (that is, the question is determined to have been answered).

A questionnaire may include a plurality of questions, and in that case, the questions may be displayed one after another such that, each time a question is answered, a next question is displayed. For example, if one of the options is selected in the state in which the questionnaire screen as shown in FIG. 7 is displayed, the display on the touch panel 25 is switched to another questionnaire screen in which a next question, options, and the like are displayed.

This way of displaying questionnaire screens allows the accesser to respond to a questionnaire by operating the touch panel 25. When the accesser has completed his/her response to the questionnaire (answered all the questions in the questionnaire) (Y in step S5), the display terminal 2 sends the thus obtained result of the response to the questionnaire (that is, information of the response result) to the server 1 (step S6).

On receiving the result of the response to the questionnaire, the server 1 sends coupon information to the display terminal 2 that has sent the result of a response to the questionnaire to the server 1 (step S14, which will be described later). Then, the display terminal 2 obtains the coupon information (step S7), and prints and ejects a service coupon based on the coupon information (step S8). Thus, the accesser obtains the service coupon in return for responding to the questionnaire. Thereafter, the process of the display terminal 2 returns to step S1.

On the other hand, the server 1 continues to observe whether or not accesser information is received from the display terminal 2 (step S11), and also continues to observe whether or not a result of a response to a questionnaire is received (step S12). If the server 1 receives accesser information (Y in step S11), the server 1 selects, from among various pieces of questionnaire information stored therein, one that is appropriate according to age (age group) and sex specified by the accesser information. And, the server 1 sends the selected questionnaire information to the display terminal 2 that has sent the accesser information to the server 1 (step S13). Thereafter, the process returns to step S12.

If the server 1 receives a result of a response to a questionnaire (Y in step S12), the server 1 selects, from among various pieces of coupon information stored therein, one that is appropriate according to the response result. Then, the server 1 sends the selected coupon information to the display terminal 2 that has sent the response result (step S14).

The server 1 updates the summary table such that the newly obtained response result is reflected therein (step S15). In this way, the results of responses to the questionnaires obtained so far are summarized. Thereafter, the process of the display terminal 2 returns to step S11.

Incidentally, the newly obtained accesser information and the result of the response to the questionnaire may be stored in the server 1 as they are. The information of the summary table and the like can be checked at any time by the administrator, the sponsor, and the like. This allows the administrator and the sponsor of the digital signage system 9 to make use of the information of the summary table and the like to expand sales of products.

With the digital signage system 9, it is possible to obtain information (trend information) regarding, for example, trends of needs and preference people have with respect to products by executing the above-described series of processes to conduct a questionnaire survey among accessers. That is, the digital signage system 9 is provided with a function of conducting trend research as well as a function of presenting information to the general public.

In the digital signage system 9, the touch panel 25 is adopted as means for presenting information to accessers and as means via which accessers input information. This makes it easier for accessers to respond to a questionnaire (input information). Furthermore, a service coupon is issued to an accesser who has responded to a questionnaire (step S8). Thus, accessers can obtain reward for responding to a questionnaire.

Thus, the digital signage system 9 is a user-friendly system in which priority is given to operability and advantages for accessers. Hence, the digital signage system 9 can be expected to encourage the largest possible number of people to respond to questionnaires. As a result, the digital signage system 9 is capable of obtaining highly reliable trend information.

Furthermore, in the digital signage system 9, a questionnaire for an accesser is selected such that its contents are appropriate according to the age and sex of the accesser. Thus, asking an accesser irrelevant questions and the like is avoided as much as possible, and thereby an effective questionnaire survey can be conducted (This minimizes the chances of asking accessers irrelevant questions and the like, and thus allows an effective questionnaire survey).

Moreover, in the digital signage system 9, a service coupon to be issued to an accesser is selected such that its contents are appropriate according to the result of the accesser's response to a questionnaire. Thus, issuing a coupon of little use value to an accesser is avoided to minimize the possibility of reducing the motivation for accessers to respond to questionnaires.

In addition, in the digital signage system 9, an image of an accesser's face is shot, and accesser information is obtained based on the thus obtained image. This makes it possible to automatically obtain accesser information whenever there is an accesser within the image shooting area (that is, whenever it is possible to shoot an image of a face of an accesser). This makes it possible to obtain accesser information without forcing accessers to input accesser information.

In the digital signage system 9, the server 1 is provided with functions of storing various pieces of questionnaire information, selecting an appropriate piece of questionnaire information based on a response result, storing various pieces of coupon information, and selecting an appropriate piece of coupon information based on a response result.

This allows operations such as additional input and partial deletion of questionnaire information or coupon information to be performed by the server 1 alone. The functional simplification reduces the cost of the display terminal 2, and as a result, even in a case in which a large number of display terminals 2 are placed, it is possible to minimize the cost of setting the digital signage system 9. Here, all of or part of the above-described functions may be provided in each of the large number of display terminals 2.

As hitherto described, the digital signage system 9 according to the embodiment of the present invention is provided with the server 1 distributing content information for an advertisement and the like, and one or more display terminals 2 that each receive the distributed content information and display it on the touch panel 25.

Furthermore, the display terminal 2 displays a questionnaire (a questionnaire screen) on the touch panel 25, accepts an accesser's response to the questionnaire by operating the touch panel 25, and sends the response result to the server 1. And, the server 1 receives the response result.

With the digital signage system 9, it is possible to conduct a questionnaire survey to obtain trend information. A questionnaires is displayed on the touch panel 25, and a response to the questionnaire is accepted via the touch panel 25. This makes it easier for an accesser to respond to a questionnaire. This promises to maximize the number of people who will respond to a questionnaire, that is, it can be expected that the largest possible number of people will input information. A “questionnaire” includes a question or questions for the general public to answer, and preferably have contents regarding, for example, needs and preferences people have with respect to products, but the contents are not limited to this.

The hitherto-described embodiment of the present invention is not meant to limit the present invention. In other words, other than the embodiment described above, many modifications and variations are possible within the spirit of the present invention.

According to the digital signage system according to an embodiment of the present invention, it is possible to conduct a questionnaire survey for, for example, obtaining trend information. And furthermore, display of a questionnaire and acceptance of a response to the questionnaire are performed through a touch panel. This makes it easier for an accesser to respond to a questionnaire. This promises to maximize the number of people who respond to questionnaires, and thus, it can be expected that the largest possible number of people will input information.

1. A digital signage system, comprising:
a server that distributes content information for an advertisement and the like; and
one or more display terminals that are provided with a touch panel and that receive the distributed content information to be displayed on the touch panel, wherein
the one or more display terminals display a questionnaire on the touch panel, accept a response to the questionnaire inputted by an accesser by operating the touch panel, and send a result of the response to the server, and wherein the server receives the result of the response.

2. The digital signage system according to claim 1, further comprising an issuing portion that issues a predetermined service coupon when the questionnaire is responded to, wherein the issuing portion prints and ejects the service coupon in the display terminals.

3. The digital signage system according to claim 2, wherein the issuing portion determines contents of the service coupon according to an answer to the questionnaire.

4. The digital signage system according to claim 1, further comprising an accesser information-obtaining portion that obtains accesser information including age and sex of the accesser, wherein contents of the questionnaire is determined according to contents of the accesser information.

5. The digital signage system according to claim 4, wherein the accesser information-obtaining portion performs shooting of an image of a face of the accesser to obtain the accesser information based on the image obtained by the shooting.

6. A digital signage system, comprising:
a server that distributes content information for an advertisement and the like; and
one or more display terminals that are provided with a touch panel and that receive the distributed content information to be displayed on the touch panel, wherein
the one or more display terminals perform shooting of an accesser's face to obtain accesser information including information regarding age and sex of the accesser based on an image obtained by the shooting, and send the accesser information to the server, wherein
the server selects, from among a plurality of pieces of questionnaire information stored therein in advance, a piece of questionnaire information that is appropriate according to the accesser information received from the display terminal as a selected piece of questionnaire information, and sends the selected piece of questionnaire information to the display terminal, wherein
the one or more display terminals further display a questionnaire screen based on the selected piece of questionnaire information received from the server, accept a response from an accesser to the questionnaire, and send a result of the response to the server, wherein
the server further selects, from among a plurality of pieces of coupon information stored therein in advance, a piece of coupon information that is appropriate according to the result of the response received from the display terminal as a selected piece of coupon information, and sends the selected piece of coupon information to the display terminal, and wherein
the display terminal further prints and ejects a service coupon based on the selected piece of coupon information received from the server.

7. A display terminal, comprising:
a touch panel; and
a communication portion that communicates with a server that distributes content information for an advertisement and the like,
the display terminal receiving content information distributed by the server to be displayed on the touch panel, wherein the display terminal displays a questionnaire on the touch panel, accepts a response to the questionnaire inputted by an accesser by operating the touch panel, and sends a result of the response to the server.

8. The display terminal according to claim 7, wherein a predetermined service coupon is printed and ejected when the questionnaire is responded to.

9. The display terminal according to claim 7, wherein shooting of an accesser's face is performed to obtain accesser information based on an image obtained by the shooting, and the accesser information is sent to the server.

10. The display terminal according to claim 7, wherein the questionnaire is displayed based on questionnaire information received from the server.

11. The display terminal according to claim 8, wherein the service coupon is printed based on coupon information received from the server.

12. The digital signage system according to claim 2, further comprising an accesser information-obtaining portion that obtains accesser information including age and sex of the accesser, wherein contents of the questionnaire is determined according to contents of the accesser information.

13. The digital signage system according to claim 3, further comprising an accesser information-obtaining portion that obtains accesser information including age and sex of the accesser, wherein contents of the questionnaire is determined according to contents of the accesser information.
